(19) United States
(12) Patent Application Publication
(10) Pub. No.: US 2002/0129271 A1
(43) Pub. Date: Sep. 12, 2002

(54) Method and apparatus for order independent processing of virtual private network protocols

(75) Inventors: John J. Stanaway JR., Wheaton, IL (US); Kumar V. Vemuri, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Lucent Technologies Inc.

(21) Appl. No.: 09/747,088

(22) Filed: Mar. 12, 2001

(51) Int. Cl. H04L 9/00

(52) U.S. Cl. 713/201; 713/150

(57) ABSTRACT

Methods and arrangements for virtual private network (VPN) data packets are disclosed. VPN packets include a payload having Internet Protocol (IP) addresses which guide the packet through a network to a security gateway. The payload may be encrypted and/or compressed and may include internal addresses to denote the real source and destination for a data portion of the payload. As initial control packets are received they are authenticated and rules and procedures are identified for proper treatment of VPN data packets bearing the same source IP address. The rules and procedures are stored in a gateway data engine having a plurality of protocol processing modules. VPN data packets are received by a protocol discriminator which reads the stored rules and procedures identified for the source IP address of the received packet. The discriminator passes the received packet to a first protocol module as identified in the stored rules and procedures. After the first module completes processing, the packet is passed back to the protocol discriminator which determines whether further protocol processing is required. When further protocol processing is required, the packet is passed to another protocol module for processing in accordance with another protocol. At the completion of processing, the second protocol module returns the packet to the protocol discriminator.

### BACKGROUND OF THE INVENTION

The present invention relates to virtual private networks for data packet communication and particularly to methods and apparatus for providing security gateway service to such networks.

Many secure or semi-secure networks exist today, which, by limiting physical access and data communication access by others, can boast a high degree of information privacy. It is desirable to permit such secure networks to communicate with sources external to the network such as remote user telecommunicaters and accordingly, some means is needed to maintain the privacy of the secure network. Security gateways have been employed to limit access to and from users outside the actual secure network. Such gateways originally screened those on the outside who were allowed to communicate over the secure network and also limited the services on the network which could be accessed by outsiders. Such original gateways did not secure the communication outside the secure network and as a result undesired communicators or communications may have had access to the secure network.

Virtual private networks (VPN) have evolved in an attempt to improve the security outside of the secure network for communicators which are permitted to enter or leave the secure network. VPNs are created by using available protocols for creating what are called VPN tunnels through a public network. The VPN protocols consist of methods for authentication, encryption, compression and otherwise protecting a data packet “payload” while communicating the packet through the public data network using normal, unencrypted public network addresses. Such normal unencrypted addresses include Internet Protocol (IP) addresses which identify the source and destination for each packet conveyed by the network. A security gateway receives the VPN packets, authenticates the communication and processes the payload in accordance with the particular VPN protocol(s) employed. The public network source and destination addresses may then be discarded and IP addresses from the protected payload used to communicate with the secure network.

The VPN protocols use preselected and/or negotiated encrypting and compressing methods and may employ public and private keys to process the VPN packets. The encryption keys for decrypting the particular encrypting and compression algorithms for a given communication may be known in advance to the VPN user and security gateway. When pre-known, they are stored in a security association (SA) database in the security gateway and used to process packets going to and from the public network. Known security gateways, however, store the SA in association with a public network IP address. As long as a given user is assigned or constrained to use the same IP address, the proper SA parameters will be identified at the security gateway. This is not how public networks normally function and accordingly, non-standard operation is needed and inefficient usage of IP addresses results.

In a normal dial-up public network connection, a user establishes a telephone connection to his or her internet service provider (ISP) which assigns an IP address to the user from a pool of available IP addresses. All communication with the user until the telephone connection is dropped uses the assigned user IP address. If the user drops the telephone connection to the ISP and then establishes a new one, a new IP address may be assigned to the user. Since the IP address of the user may change over time, a security gateway cannot establish an SA entry for that user since it cannot be identified by a consistent IP address. Additionally, problems exist in the security gateway itself regarding the unpacking of a VPN payload. For full security at the secure network it is important that the VPN payload be decrypted and compressed before the security network is entered. An incoming packet, however, may have been processed in accordance with any of a number of VPN protocols and sometimes by multiple VPN protocols in sequence. Unless the payload is treated in accordance with the same protocols in the reverse sequence in which they were used to create the payload, the content of the payload will be lost. Prior VPN systems have matched packets closely to gateway processes which are identical in a reverse sense to the encryption protocols. Thus, it must be known a priori what VPN protocols have been used and their sequence of use and one or more processing modules must be provided for each combination of protocols. This leads to inefficient use of hardware or processor time. Thus, the possibility of using multiple VPN protocols creates additional problems in the art.

### SUMMARY

A method and apparatus in accordance with the present invention receives VPN packets processed in accordance with one or more VPN protocols and properly terminates those protocols in the appropriate sequence. A security gateway receives VPN control and data packets communicated between a public data network and a corporate network. As initial control packets are received they are authenticated and rules and procedures are identified for proper treatment of VPN data packets bearing the same source IP address. The rules and procedures are stored in a gateway data engine having a plurality of protocol processing modules.

VPN data packets are received by a protocol discriminator which reads the stored rules and procedures identified for the source IP address of the received packet. The discriminator passes the received packet to a first protocol module as identified in the stored rules and procedures. After the first module completes processing, the packet is passed back to the protocol discriminator which determines whether further protocol processing is required. When further protocol processing is required, the packet is passed to another protocol module for processing in accordance with another protocol. At the completion of processing, the second protocol module returns the packet to the protocol discriminator. When the protocol discriminator determines that no further protocol processing is required, the packet as processed by one or more of the protocol modules is sent on to a packet filter and address translator for transmission to the corporate network. In a similar but reverse manner, the gateway data engine receives packets from the corporate network and processes them in the proper sequence using the plurality of protocol modules.

Advantageously, a first of the protocol modules processes layer 2 VPN protocols such as point-to-point tunneling protocol (PPTP) and layer 2 tunneling protocol (L2TP). Another of the protocol modules handles layer 3 VPN protocols of which the IP security (IPSec) protocol is an example. By operation in accordance with the embodiments herein, packets having layer 2 or layer 3 VPN tunnels or a combination of layer 2 and layer 3 tunnels can be properly terminated at a gateway and created at the gateway for transmission to a user (client) via a public data network.

### BRIEF DESCRIPTION OF THE DRAWINGS

A more complete understanding of the present invention will be gained from consideration of the following description when read in conjunction with the drawing in which:

FIG. 1 is a block diagram representing communication with a secure network through a public network;

FIG. 2 is a block diagram of portions of a security gateway of FIG. 1;

FIG. 3 represents a virtual private network from a user/client to a secure network;

FIG. 4 represents a virtual private network from an internet service provider to a secure network;

FIGS. 5(a) and 5(b) are block diagrams representing virtual packet protocol structure and construction from a user/client to a secure network; and

FIG. 6 is a block diagram of an embodiment of a gateway data engine of FIG. 2.

### DETAILED DESCRIPTION

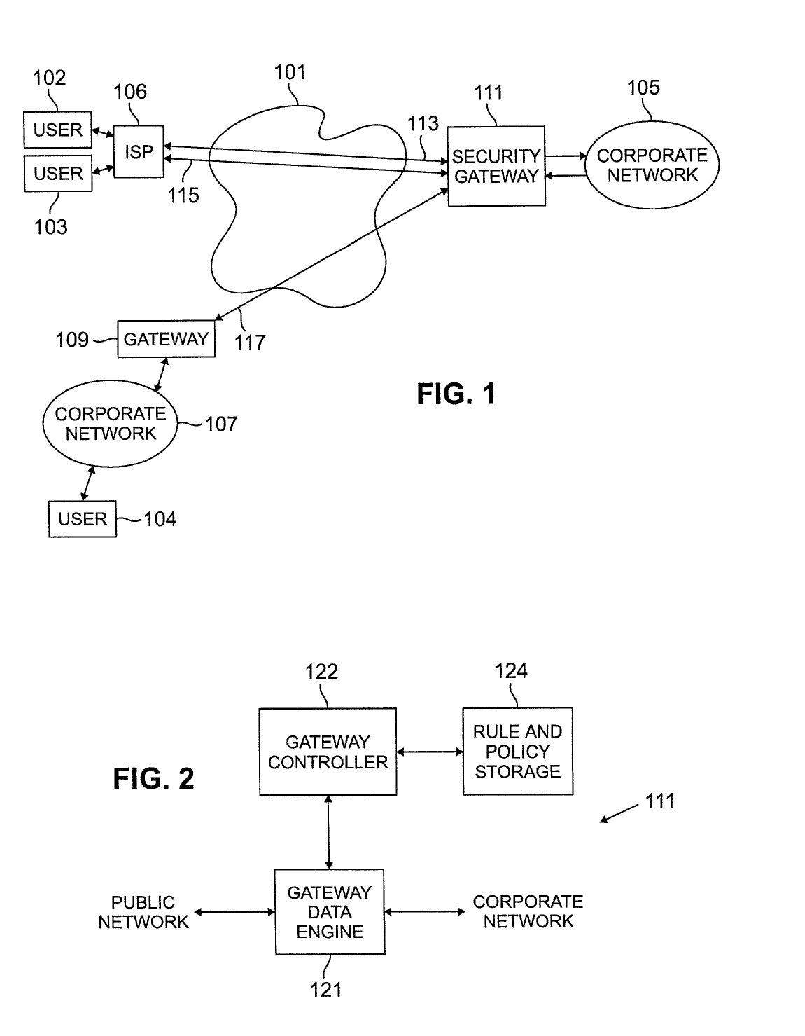

FIG. 1 illustrates a data network system in which a public network 101, such as the Internet, is used to interconnect users 102, 103 and 104 and a secure corporate network 105. Users 102 and 103 are connected to the public network 101 via an internet service provider (ISP) 106. User 104 is connected to the public network via a corporate network 107 and a gateway server 109. Communications between the corporate network 105 and the public network 101 are controlled by a security gateway 111 which provides, among other services, virtual private network services and data filtering services for corporate network 105. Public network 101 is a TCP/IP network and communication is by means of IP addressed datagrams or packets. In order to provide communication security, users 102-104 may communicate with corporate network 105 over virtual private networks (VPN) which are represented as 113, 115 and 117.

A VPN consists of an encrypted data payload which is transmitted by the communicating endpoints with non-encrypted encrypted source and destination IP addresses for conveyance by the public network. Due to the protocols employed to establish the VPN, the payload is protected from security threats in the public network giving secure networks such as corporate network 105 the confidence to allow the exchange of data over the public network. Many different systems exist for creating and using VPN. The different systems involve different types or choices of encryption and rely on different encryption keys for proper processing. Additionally, some VPN protocols allow compression and provide internal authentication of the data in the payload. Lastly, the different protocols may operate at different layers of the open systems interconnection (OSI) model.

A virtual private network begins with a request from a user, such as user 102, to dial up ISP 106. The ISP authenticates the user by login and password with a protocol such as the well-known RADIUS and, upon proper authentication, assigns the user an IP address from a pool of IP addresses controlled by the ISP. The user then begins a process for the establishment of a VPN using the assigned IP address to set up a channel for session level authentication at the security gateway 111. The first packet transmitted to the security gateway identifies as a non-encrypted destination, the IP address of the gateway 111 and includes internal data which the gateway interprets as a request to establish a session. The internal data will include among other items, user name, e.g., client 102, password and a security ID. The packet will be conveyed to a data engine 121 (FIG. 2) of the security gateway 111. The data engine interprets the packet as a control packet and forwards it to a gateway controller 122. The data portion or payload of the first packet will be encrypted in a manner known by the gateway controller 122 which initiates a controller thread to manage the requested session. Initially, the controller thread decrypts the packet data, identifies the user identity, password and security ID. An authentication protocol such as RADIUS is then performed to authenticate the user's access. If authentication fails, the connection is dropped. Alternatively, if authentication is successful the controller thread begins the processes needed to establish and maintain a VPN connection.

The VPN is in essence an encrypted payload which negotiates the public network by means of non-encrypted source and destination IP addresses. The user's IP address is the IP address assigned by the ISP. The security gateway IP address is previously known to the user. The encryption of the payload, including data encryption, data authentication and compression, requires that both the user and the security gateway are aware of the types of encryption, authentication and compression being employed and that any necessary keys have been exchanged. If this is a first communication from a user to the security gateway, a negotiation will take place to properly inform both the user and the gateway how the payload is to be processed. Such negotiation is known in the art and not discussed in detail herein. The parameters representing the negotiated keys and protocols are then stored in the user's computer and in a Security Association (SA) in the storage 124 of the security gateway. The SA is stored in a table with the SAs for other VPNs and is accessible using the user's user identity. If the present request for a VPN is not the first communication between security gateway and the user, the gateway controller accesses the previously negotiated SA from storage 124, stores it in the gateway data engine 121 and binds it to the IP address of the user as assigned by the ISP. As subsequent packets are received in the same session, the data engine 121 accesses the SA bound to the assigned user IP address and properly decrypts the packet payload. At the end of the session the gateway controller unbinds the SA from the assigned IP address.

After the user of a VPN is authenticated, VPN packets can be properly received and decrypted for communication on the corporate network 105 and packets from the corporate network can be encrypted and sent to the user 102. The security gateway also includes features to potentially limit each user's access to parts of the corporate network. It is therefore necessary to identify the policies and conditions under which the user will be permitted to exchange packets with services on the corporate network. The exchange of packets is controlled by a packet filter which operates in accordance with data defining a user's access to corporate network services to actually grant or deny access to the network. The database of the gateway controller stored in storage 124 includes user identity bound service mappings which define user access to the corporate network. The user identity which is obtained after authentication of the user, is used to access the database of the gateway controller for the service mappings bound to that user identity. Those service mappings are forwarded to memory of the data engine and bound to the ISP-assigned IP address of the user. As each VPN packet is received and decrypted it is sent on to a data filter for granting or denying access to the corporate network. Similarly, packets from the corporate network containing the user's assigned IP address are screened by the data filter before being encrypted and sent on to the user via the VPN.

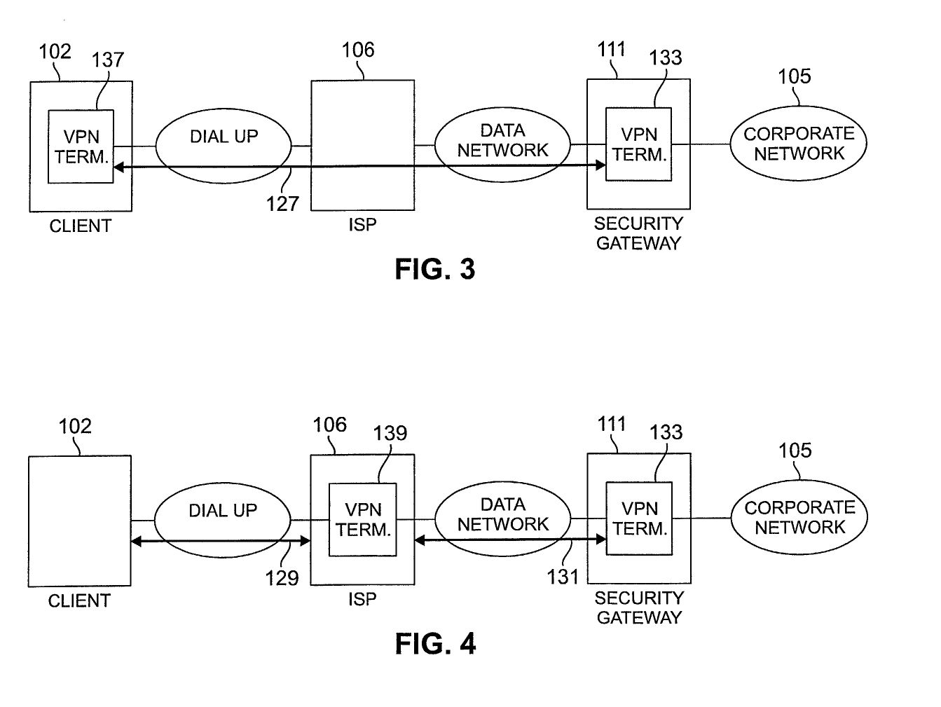

The preceding description assumed that the VPN was terminated at the user end in the user computer 102 and at the other end in the security gateway 111. FIG. 3 shows a VPN connection from user 102 to security gateway 111 via the single bold colored connection 127. FIG. 4 shows an alternative VPN connection in which a normal (non-VPN) PPP connection exists between user 102 and security gateway 111. In FIG. 4 the VPN termination for the user resides in the ISP 106. Accordingly, user 102 communicates with the ISP106 via a normal PPP connection 129. The VPN termination 139 in the ISP then properly encrypts and decrypts payloads destined for the VPN termination 133 of security gateway 111. It should be mentioned that the VPN terminations 137 and 133 and 139 and 133 must be compatible so that packets can be properly communicated.

A plurality of VPN protocols are available today and it is expected that more will be available in the future. Some of these protocols operate at layer 2 of the open systems interconnection model and some operate at layer 3. The various VPN protocols provide different methods of encryption, authentication and compression such that both ends of a VPN must practice the same protocol. Layer 2 protocol solutions include point-to-point tunneling protocol (PPTP) and layer 2 tunneling protocol (L2TP). For PPTP the VPN tunnel originates at a PPTP access concentrator (PAC) and terminates at a PPTP network server (PNS). The comparable entities in L2TP are the L2TP access concentrator (LAC) and the L2TP network service (LNS). When a layer 2 VPN tunnel is established between a client and a security gateway (FIG. 3), the PAC or LAC is the VPN termination 137 on the client 102 and the PNS or LNS is the VPN termination 133 on the security gateway 111. Similarly, when a layer 2 VPN tunnel is established between an ISP and the security gateway 111 (FIG. 4), the PAC or LAC resides at the ISP for communication with the PNS or LNS at the gateway. A layer 3 tunneling protocol is represented by the IP security protocol suite (IPSec) which also provides a set of features by which a secure VPN communication may be undertaken. IPSec can be used to provide a VPN tunnel between a client and a security gateway or between an ISP and a security gateway as shown in FIGS. 3 and 4, respectively.

The layer 2 and layer 3 protocols are not described herein in detail as they are well known in the art. The establishment of a VPN tunnel in a given protocol requires a predetermined capability set at both ends to continue the tunnel and the capabilities of one protocol will not complete a tunnel with another protocol. Thus, each VPN protocol requires specific termination. Additionally, it is possible that VPN tunnels will be created which include attributes of more than one protocol. For example, security demands may require the establishment of a tunnel within a tunnel such as a layer 2 tunnel within a layer 3 tunnel. That is, a first set of layer 2 protocols may be employed to packets, then a second set of layer 3 protocols before they are sent to the network, e.g. 101. The security gateway must then perform the proper layer 2 and layer 3 protocols in the reverse order to properly obtain the packet payload.

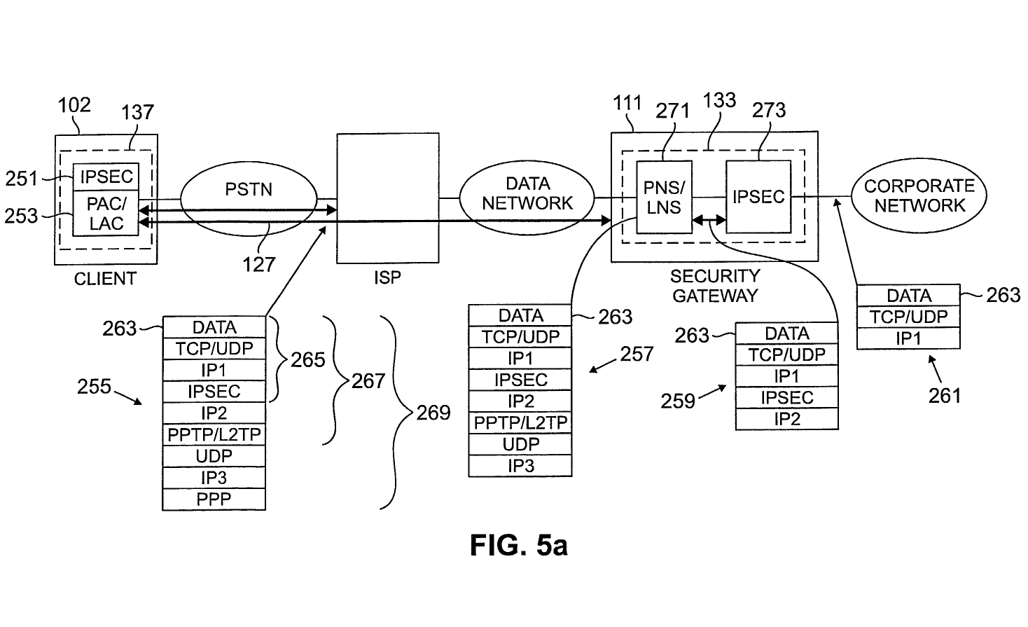

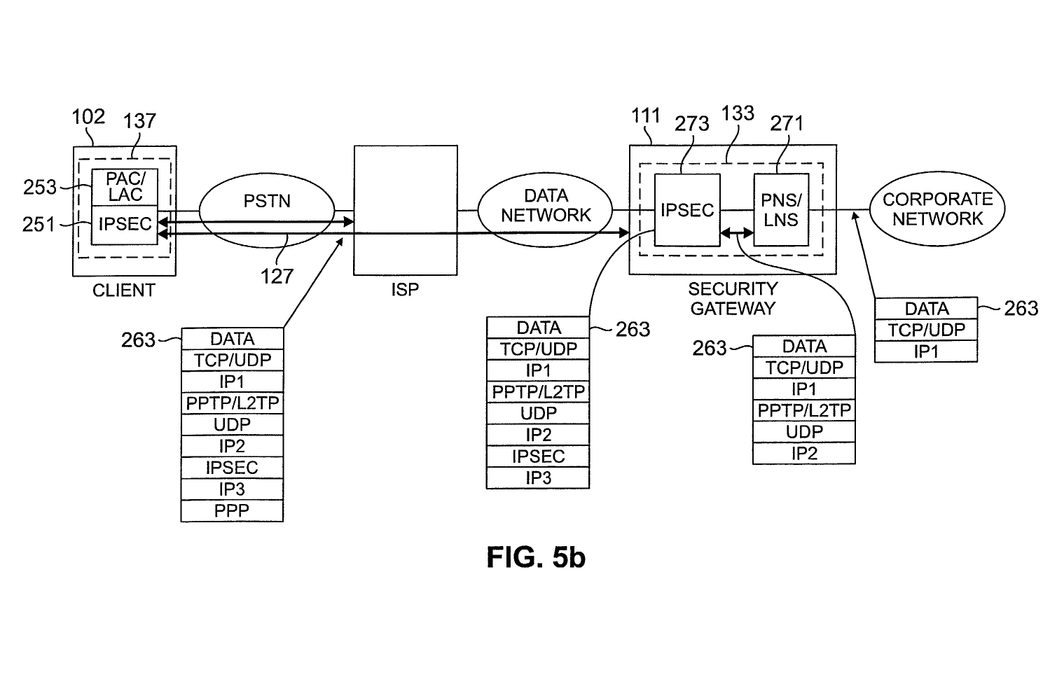

FIGS. 5(a) and 5(b) are block diagrams representing two examples of a first security protocol being tunneled within a second security protocol which result is sent over the public network. FIG. 5(a) represents an IPSec protocol tunneled within a PPTP/L2TP protocol which forms the payload of packets exchanged over the public between client 102 and gateway 111. In FIG. 5(a) the client 102 includes an IPSec protocol unit 251 which first handles packets of data and conveys the treated packets to a PAC/LAC protocol unit 253. After the protocol unit 253, the packets are given IP source and destination addresses for conveyance over the public network via communication path 127.

FIG. 5(a) includes a plurality of packet representing rectangles 255, 257, 259 and 261 each representing security protocol results of packet handling at portions of the communication path. In rectangle 255, representing packets on communication path 127, original user data 263 is incorporated with in the IPSec protocol represented by the bracketed items 265. It should be mentioned that the TCP/UCP included within 265 refers to the well known Transmission Control Protocol or the User Datagram Protocol. Additionally, the content of bracketed items 265 is processed in accordance with the PPTP/L2TP protocol as represented by 267. Lastly, the result is collected into a PPP (point-to-point protocol) packet 269 for communication over the public network. At the security gateway 111, the PPP protocol is resolved and the PPP source and destination addresses IP3 are used for proper handling by the PNS/LNS protocol unit 271. Thereafter, the remaining packet portions 263 which include a source and destination address IP2 are used by the IPSec protocol unit 273 to finally resolve the incoming packet into the data 263, protocol and IP address IP1 originally provided by its user. The reverse operation of constructing and transmitting packets is also performed by processing in protocol units 273, 271, 253 and 251 in sequence.

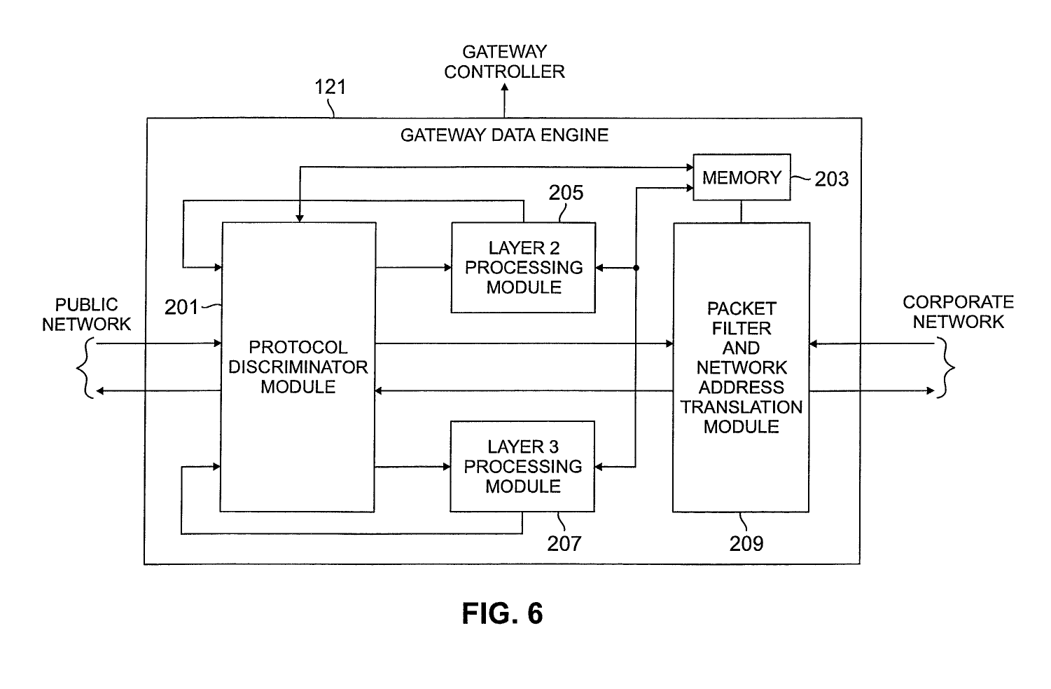

FIG. 5(b) is not described in detail herein but it represents the same protocol-within-protocol packet handling as illustrated in FIG. 5(a) except that the sequence of the protocol units 251 and 253 is reversed as is the sequence of the protocol units 271 and 275. Whereas the security gateways of FIGS. 5(a) and 5(b) must be closely matched to their communicating clients, FIG. 6 illustrates a data engine for a security gateway which does not require identical protocol matching to that of the client.

FIG. 6 is a block diagram of a gateway data engine 121 (see FIG. 2) capable of applying proper protocols to incoming packets to provide proper VPN tunnel termination for layer 2 and 3 protocols as well as for packets treated in accordance with multiple protocols. It should be mentioned that additional protocols to those referenced in FIG. 6 may be terminated by the gateway by providing additional modules similar to modules 205 and 207 for the additional protocols. The illustrated gateway data engine also provides necessary firewall features such as packet filtering and translation of network addresses.

The gateway data engine 121 of FIG. 6 receives packets at a protocol discriminator 201 which inspects packets incoming from the public network to identify the type of processing needed. As discussed above, VPN packets received by the gateway data engine of the security gateway (FIG. 2) identify their IP source and destination addresses for conveyance through the public network. Further, the initial packet or packets of a session are control packets which are sent to the gateway controller from which authentication is achieved. The gateway controller (FIG. 2) as a part of session establishment also identifies the policies for the VPN protocol employed for each packet. These policies are bound to the source and destination addresses associated with packets. The gateway controller 122 then writes into memory 203 the nature policies of protocol processing needed for incoming packets having the source and destination addresses of the subject packet. After the session is authenticated and the memory 203 is written, data packets are received at the data engine 121 by a protocol discriminator 201. Based on the source and destination addresses of an incoming packet, protocol discriminator 201 identifies which protocols are to be employed using policies associated with these addresses. When layer 2 protocol is to be first used, the packet is passed to a layer 2 processing module 205 which processes the packet in accordance with a predetermined layer 2 protocol (e.g. performs the function of a PNS or LNS) and returns the processed packet to the protocol discriminator 201. The discriminator then determines if layer 3 protocol processing should be done and if so, the packet is sent to a layer 3 processing module 207. At the completion of layer 3 processing the packet is returned to protocol discriminator 201 and forwarded to a firewall processing module 209 for packet filtering and address translation. When the protocol discriminator receives a packet from the public network, it may first require layer 3 processing. In such a case the packet will first be sent from protocol discriminator 201 to layer 3 processing module 207. At the completion of layer 3 processing the packet is returned to the protocol discriminator 201 from which it may be passed to the layer 2 processing module 205 or directly to the firewall module 209 as identified by the protocol data in memory 203.

Packets received by the gateway data engine from the corporate network, e.g. 105, are passed through the firewall module 209 to the protocol discriminator 201. Based on the source and destination addresses of packets from the firewall module 209, the protocol discriminator passes the packet on to the layer 3 processing module 207 and/or the layer 2 processing module 205 as needed to properly communicate through the public network 101 with the communicating client, e.g. 102. After processing by the gateway data engine, the packet in proper VPN format is sent to the public network 101.

It is understood that the above described embodiments are merely descriptive of the principles of the invention and that many variations may be devised by those skilled in the art without departing form the scope of the invention. It is intended that such variations be included within the scope of the claims.

What is claimed is:

1. A security gateway for interfacing between virtual private network data packets and corporate network packets, each data packet comprising address information, the security gateway comprising:
a plurality of protocol modules each for processing packets in accordance with a different virtual private network protocol;
memory for storing sequence information identifying which of the protocol modules is to process each packet and the order of the processing;
a protocol discriminator for receiving data packets and being responsive to the address information of a received data packet for passing the received data packet to one or more of the protocol modules, for processing thereby in the sequence identified by the protocol sequence information.

2. A security gateway in accordance with claim 1 wherein each protocol module receiving a data packet passes the received packet back to the protocol discriminator upon completion of processing.

3. A security gateway in accordance with claim 2 wherein the protocol discriminator selectively sends a data packet received from one of the protocol modules to another of the protocol modules.

4. A security gateway in accordance with claim 3 comprising a firewall interface to a corporate network and the protocol discriminator passes data packets to the firewall interface after processing by one or more of the protocol modules.

5. A security gateway in accordance with claim 1 wherein one of the plurality of protocol modules processes virtual private network packets at a level 2 communication layer and another of the plurality of protocol modules processes virtual private network packets at a level 3 communication layer.

6. A security gateway in accordance with claim 5 wherein the one protocol module processes point-to-point tunneling protocol and layer 2 tunneling protocol.

7. A security gateway in accordance with claim 5 wherein the another protocol module processes packets in the IPSec protocol.

8. A security gateway in accordance with claim 1 comprising a packet filter responsive to address information in packets presented thereto for selectively granting and denying communication with the corporate network.

9. A security gateway in accordance with claim 8 comprising a stored table of access rules and the packet filter responds to the access rules for selectively granting and denying communication with the private network.

10. In a security gateway for interfacing between virtual private network packets and corporate network packets, each packet comprising address information and a plurality of protocol modules each for processing packets in accordance with a different virtual private network protocol, the method comprising:
storing protocol sequence information identifying which of the protocol modules is to process each packet and the order of the processing;
receiving data packets and responsive to addressing information of a received data packet, sending the received data packet to one or more of the protocol modules, for processing thereby in the sequence identified by the protocol sequence information.

11. A method in accordance with claim 10 comprising accumulating the protocol sequence information during authentication of one or more communication request packets.

12. A method in accordance with claim 10 comprising processing virtual private network packets at a level 2 communication layer in one of the plurality of protocol modules and processing virtual private network packets at a level 3 communication layer in another of the plurality of protocol modules.

13. A method in accordance with claim 10 comprising selectively granting and denying communication with the corporate network.

14. A method in accordance with claim 13 comprising storing a table of access rules upon which granting and denying communication with the private network is based.

15. A method of operating a security gateway in a virtual private network in which a user is assigned an IP address on a per session basis, the method comprising:
receiving at the security gateway a network packet and ascertaining from the packet the assigned IP address and the identity of the user initiating the packet;
identifying from storage at the security gateway rules and policies specifying permissions for the identified user to communicate and VPN protocols for packets from the identified user;
binding a portion of the rules and policies for the identified user to the assigned IP address of the user;
processing received packets in a plurality of protocol modules in accordance with the identified VPN protocols; and
controlling virtual packet network security functions for packets from the user under direction of data in the rules and policies bound to the assigned IP address of the user.

16. A method in accordance with claim 15 wherein the rules and policies comprise data defining the security associations for communication between the user and the security gateway.

17. A method in accordance with claim 15 wherein the rules and policies comprise data for controlling access by the user to processes and data on a private network.

18. A method in accordance with claim 15 wherein the identifying step comprises negotiating VPN protocol attributes between the user and the security gateway.
